(19) United States
(12) Patent Application Publication
(10) Pub. No.: US 2006/0185177 A1
(43) Pub. Date: Aug. 24, 2006

(54) Integral utensil and clip

(76) Inventor: Jo-Anne Simard, Laval (CA)

Correspondence Address: Mrs. Jo-Anne Simard, 6863 Boul Des Laurentides, Laval, QC, H7H 3A1, CA

(21) Appl. No.: 11/191,213

(22) Filed: Jul. 28, 2005

(30) Foreign Application Priority Data
Jan. 24, 2005 (CA) 2,489,633

(51) Int. Cl. A47J 43/28

(52) U.S. Cl. 30/327

(57) ABSTRACT

The present invention is concerned with a utensil provided with an integral clip device for securing the utensil to a top portion of a generally vertically extending wall defining an inner face and an outer face. The utensil comprises a proximal handle portion, and a distal efficient portion having a back portion defining a first surface and a tab defining a second surface extending generally parallel to said first surface and proximate thereto, whereby the utensil can be secured to the wall with the handle portion extending generally upward, by engaging the wall between the first surface and the second surface.

### FIELD OF THE INVENTION

The present invention generally relates to devices for holding kitchen utensils. More specifically, the present invention is concerned with a kitchen utensil such as a spoon, ladle, fork, or spatula, provided with an integral clip cooperating with a utensil efficient portion for attaching the utensil to a rim of a container such as a pot, a saucepan or a bowl.

### BACKGROUND OF THE INVENTION

Properly holding, hanging or supporting a kitchen utensil such as a spoon or ladle during use in cooking or serving is a concern that has deserved a fair level of attention over the past years. Indeed, the kitchen utensil, such as a spoon used for stirring food in a pan, for example, is repeatedly put in contact with food ingredients and accumulates residues from the food on the efficient portion thereof. It is generally not desirable to leave the utensil leaned inside the container between uses, as it can interfere with food preparation or slide too deeply into in the food and have its handle portion soiled. Therefore, soiled kitchen utensils typically need to be repeatedly put aside out of the container for certain periods of time, and are thus a potential cause of dirtying of the peripheral area such as cook-stove, counter, appliances, table, floor, pieces of furniture, clothes, etc. by direct contact or by dripping. The utensil being put aside may also be subject to damages such as burning or melting that can be caused by a heat source or a hot surface.

Miscellaneous types of stands, holders or rests to be placed on a stove, a counter or a table and on which a utensil can be momentarily deposited nearby a container are well known for years. Although these products are designed to prevent direct contact with other surrounding surfaces, dripping along the paths separating the device form the container(s) may still occur. Besides this limitation, the device itself has nevertheless to be washed thoroughly after use, and one may have to rely on as many devices as the number of utensils used during preparation or serving. One must also consider the cost of buying the devices, as well as the necessity of storing them around the kitchen and retrieving them when needed. Moreover, depositing an efficient portion of a kitchen utensil to be reused into the food onto such a device may create contamination of the food by transportation of contaminants present on the device.

Another type of devices, comprising clips or holders and/or clamps to be temporarily attached to a rim of a container to hold a cooking utensil, have also been proposed to address the problem. Their basically valuable concept aims at maintaining the efficient portion of the utensil above the container, to prevent the utensil from falling or sliding into the food and dripping out of the container. Examples of such devices are taught in U.S. Pat. No. 1,483,833 issued in 1923 to Potter, U.S. Pat. No. 3,931,668 granted to Hombach in 1976, U.S. Pat. No. 5,518,211 granted to Gaskill et al. in May 1996, and U.S. Pat. No. 5,730,405 issued to Nichols on Mar. 24 1998. These holding devices fail to propose a really universal structure, which can be conveniently used to retain different types of utensil in a user friendly manner. Again, these devices must further be bought separately from the utensil or cookware, must be stored in the kitchen and retrieved when needed, and washed after use, which may rapidly discourage usage. Using such a device is also inappropriate when more than one utensil are being used simultaneously.

It is also a common practice to provide kitchen utensils such as, spoons, ladles, spatulas and forks with a hook at the proximal end of the handle thereof to enable suspension of the utensil to a supporting device such as flat bar or loop provided nearby the cooking area. Openings or hooks provided at the proximal or median portion of especially long handles, most often fabricated through punching and/or stamping of the handle material, have also been contemplated in the prior art. Peg bars or straight edges can be used to suspend such utensils. However, dripping along the paths traveled between the containers and the supporting device are still likely to occur and require cleaning. Also, even though hooks may be provided, their position on the handle is such that suspension from a rim of a typical container can not be envisaged since it would not allow the efficient distal portion of the utensil to clear the container supporting surface, most often being a heating surface, since the overall length of the utensil is usually much greater than the height of the container. This is especially true when using a low profile pan.

However, a few prior patents disclose holding devices formed integrally into an implement, at a position proximal to the efficient portion thereof, to enable the implement to be attached to a rim of a container. In U.S. Pat. No. 5,201,121 issued to Heiberg in April 1993, a kitchen implement is provided with a mounting opening through the implement sheet material forming a pair of arcuate edges and an outer projecting lip for engagement with outer and inner surfaces of a bowl to mount the implement thereto. Similarly, Desjardin in U.S. Pat. No. 5,065,977 granted on Nov. 19 1991, teaches a tool wherein an opening is provided through a flat heel portion of a flat blade, defining a resiliently flexible tongue and a pair of shoulders cooperating with the tongue to engage a groove in an annular rim of a container and thereby clipping the tool onto the rim with the blade extending vertically into the container.

Although such integral implement mounting devices successfully enable an implement to be held on a rim of a container with its efficient portion extending into the container, their structures are not suitable for application to kitchen utensils requiring a solid fluid tight and often elongated efficient portion. Furthermore, they could not comply with utensils often provided with an elongated handle portion causing the center of gravity of the utensil to be located above the mounting device, which would render the mounting unstable and cause flipping of the utensil out of the container.

Although the above examples show that some solutions have been contemplated in the prior art to address the problem of temporarily holding utensils during use in cooperation with a container, these devices are nevertheless presenting major limitations and drawbacks and are lacking important features necessary for them to provide a convenient, efficient and cost effective solution to that concern.

It would therefore be a significant advance in the art of utensil and implement supporting devices and systems to provide a utensil or implement wherein a clip is integrated and cooperating with a distal efficient portion thereof, thereby enabling direct clipping of the utensil or implement to rims of containers, including most low profile pans, without compromising the functional integrity of the utensil or implement.

### OBJECTS OF THE INVENTION

An object of the present invention is therefore to provide an integral utensil and clip device obviating the limitations and drawbacks of the prior art devices and systems.

### SUMMARY OF THE INVENTION

More specifically, in accordance with the present invention, there is provided a utensil with integral clip device for securing the utensil to a top portion of a generally vertically extending wall defining an inner face and an outer face. The utensil comprises a proximal handle portion and a distal efficient portion having a back portion defining a first surface and a tab defining a second surface extending generally parallel to said first surface and proximate thereto, whereby the utensil can be secured to the wall with the handle portion extending generally upward, by engaging the wall between the first surface and the second surface.

There is further provided a utensil wherein said tab defines a free end, said free end cooperating with said first surface to define a tapering inlet.

There is further provided a utensil wherein the second surface includes a groove, transversal to a major axis of the utensil, for nesting at least a portion of a lip extending outwardly from said outer face of said wall.

There is further provided a utensil wherein said groove defines at least one chamfered edge.

There is further provided a utensil wherein the second surface includes a protruding portion for engaging the outer face of the wall at at least one point of contact.

There is further provided a utensil wherein the second surface includes a pair of protruding portions for engaging the outer face of the wall at at least two points of contact, transversally spaced-apart with respect to a major axis of the utensil.

There is further provided a utensil wherein the tab includes a resilient member whereby the spacing between the second surface and the first surface can be slightly expanded for engaging the wall therein.

There is further provided a utensil wherein the tab includes a resilient member whereby the spacing between the second surface and the first surface can be slightly expanded for engaging the wall with a clamping force.

There is further provided a utensil wherein the tab includes a root connecting the second surface to the first surface, said root defining a stop member adapted to abut on a top edge of the wall.

There is further provided a utensil wherein said tab defines a free end, and the second surface has a portion converging with at least a portion of the first surface in a direction extending from the root to said free end.

There is further provided a utensil wherein at least the first surface and the second surface include a resilient material.

There is further provided a utensil wherein the efficient portion includes an external efficient surface made of resilient material and a core made of a harder material, the handle portion being made from said harder material extending into the efficient portion to form the core thereof.

There is further provided a utensil wherein the first surface is solid and generally flat.

There is further provided a utensil wherein the first surface includes a protruding portion for engaging the wall at at least one point of contact.

There is further provided a utensil wherein the first surface includes a pair of protruding portions for engaging an inner face of the wall at at least two points of contact, transversally spaced-apart with respect to a major axis of the utensil.

There is further provided a utensil wherein the back portion of the efficient portion defines a fore portion and heel portion connected to the handle portion, the tab extending from said heel portion so that the tab does not extend beyond a virtual plane generally defined by the fore portion.

There is further provided a utensil with integral clip device for securing the utensil to a top portion of a container having a generally vertically extending wall defining an inner face, an outer face and a top edge, the utensil comprising: a proximal handle portion, and a distal efficient portion having a back portion defining an inner face engaging surface and a tab, said tab including i) an outer face engaging surface extending generally parallel to said inner face engaging surface and proximate thereto, ii) a root connecting said outer face engaging surface to said inner face engaging surface and defining a stop member, and iii) a free end cooperating with said inner face engaging surface for forming a tapering clip inlet, whereby the utensil can be secured to the wall of the container with the handle portion extending generally upward, by inserting the wall through the inlet, for engaging the inner face with the inner face engaging surface, the outer face with the outer face engaging surface, and abutting the top edge on the stop member.

There is further provided a utensil wherein said outer face engaging surface includes a protruding portion near said free end for engaging the outer face of the wall at at least one point of contact.

There is further provided a utensil with integral clip device for securing the utensil to a top portion of a generally vertically extending supportive wall defining an inner face, an outer face and a top edge, the utensil comprising: a proximal handle portion, a distal efficient portion having a back portion defining a first surface, and a tab portion, said tab including i) a second surface extending generally parallel to said first surface and proximate thereto, ii) a collar assembled adjacent said first surface, iii) a root connecting said second surface to said collar and defining a stop member, and iv) a free end cooperating with said first surface for forming a clip inlet, whereby the utensil can be secured to the wall with the handle portion extending generally upward, by inserting the wall through the inlet, for engaging the inner face with the first surface, the outer face with the second surface, and abutting the top edge on the stop member.

There is further provided a utensil wherein said collar is removably assembled between said handle portion and said efficient portion on a connecting member extending distal from said handle and engaging into said efficient portion for removably attaching said efficient portion to said handle portion.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1 is an isometric view an integral utensil and clip device according to the present invention, attached to a peripheral wall of a cookware article;

FIG. 2 is a frontal view of an integral utensil and clip device according to the present invention;

FIG. 3 is a lateral view of the integral utensil and clip device of FIG. 2;

FIG. 4 is a view from the back of the integral utensil and clip device of FIG. 2;

FIG. 5 is an alternate embodiment of the integral utensil and clip device provided with a non converging tab;

FIG. 6 shows the integral utensil and clip device of FIG. 2 just prior to attachment to a wall of a cookware article;

FIG. 7 shows the integral utensil and clip device of FIG. 2 attached to a wall of a cookware article;

FIG. 8a is a detailed lateral cross sectional view of a clipping portion of an integral utensil and clip device according to an embodiment of the present invention;

FIG. 8b is top cross sectional view according to line BB of FIG. 8a;

FIG. 9 is a detailed top cross sectional view of a clipping portion according to an alternate embodiment of the present invention;

FIG. 10 is a lateral cross sectional view of a spatula according to the present invention.

FIG. 11 is a lateral view of a spatula according to the present invention, wherein a clip is removably assembled adjacent to an efficient portion thereof.

Identical numerals in the drawings represent similar parts throughout the description.

### DETAILED DESCRIPTION

Generally stated, the present invention relates to an integral utensil and clip device 1 for attachment to a generally vertical wall 101, as illustrated in FIG. 1. Although the invention will be described referring to a spoon 1 destined to be attached to a rim or peripheral wall 101 of a cookware article such as pan 100, it is contemplated that different utensil can be provided with a similar clipping structure, with equal benefits and without departing from the spirit of the invention. For example, different types of ladles, forks and spatulas can be contemplated as well. Also, clipping of the utensil onto a wide range of articles comprising generally vertically extending thin walls can be contemplated.

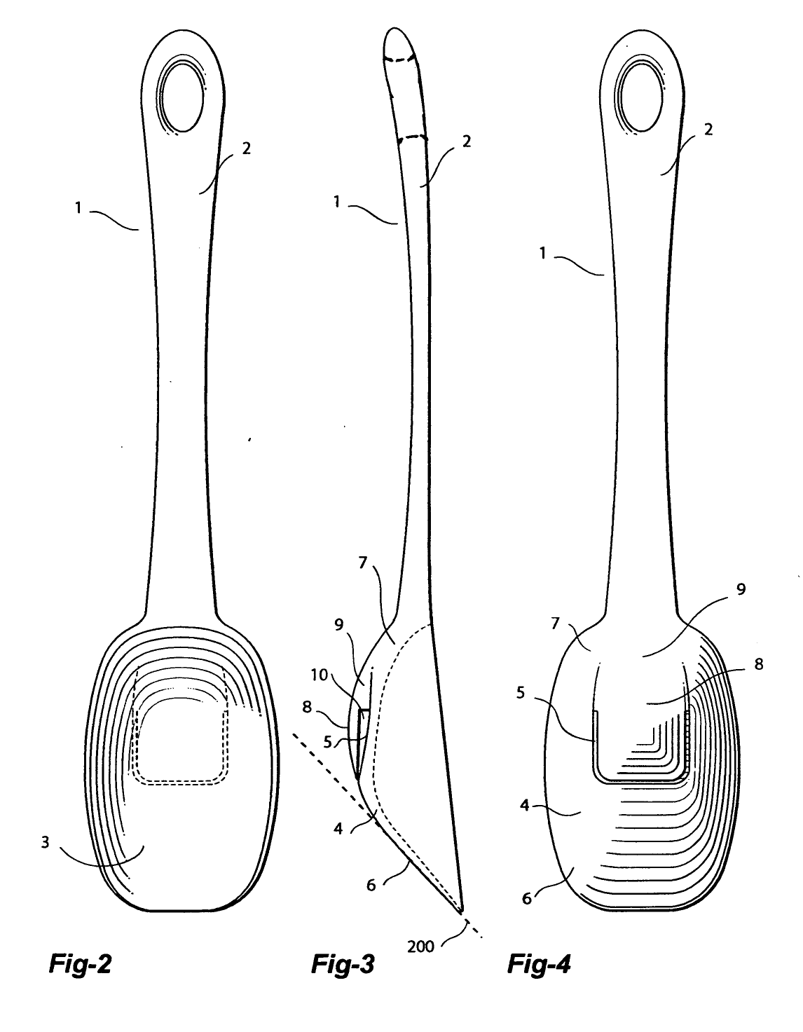

The utensil 1 comprises a proximal handle portion 2 and a distal efficient portion 3 represented by a fluid tight receptacle (see FIGS. 2 and 3) connected to handle 1. The efficient portion comprises a back portion 4 comprising an inner face engaging surface 5 for engaging an inner surface 102 of wall 101 of pan 100. The back portion further defines a fore portion 6 and a heel portion 7 and comprises a tab 8 extending generally parallel to inner face engaging surface 5, and being attached to the heel portion 7, through root portion 9. It should be noted that in other embodiments involving different shapes of efficient portions, tab 8 can be connected to a median portion of the back portion, between the fore portion and the heel portion, as long as proximity to the distal end of the utensil can be increased without compromising proper operation of the utensil.

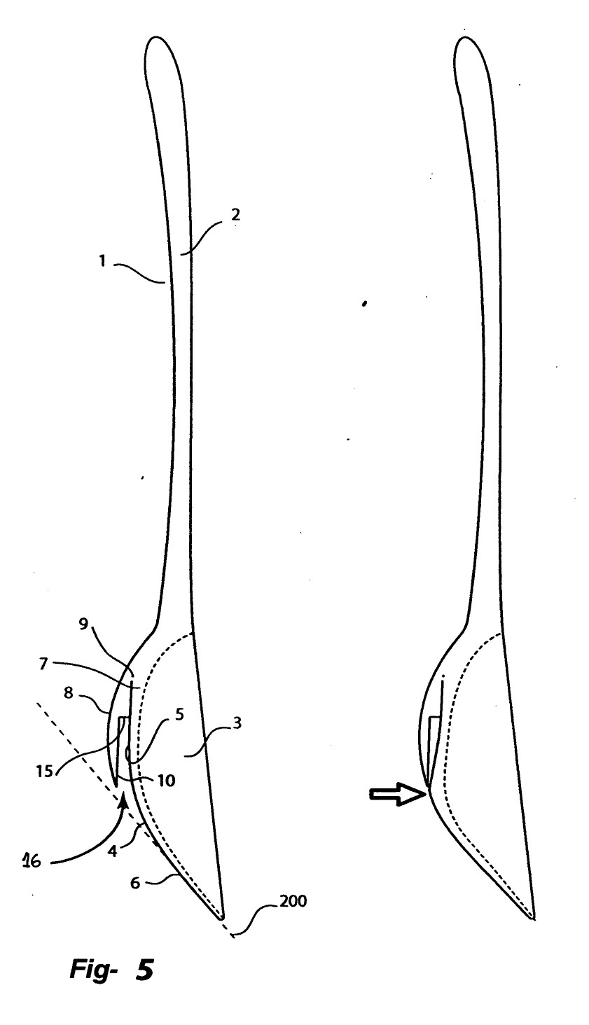

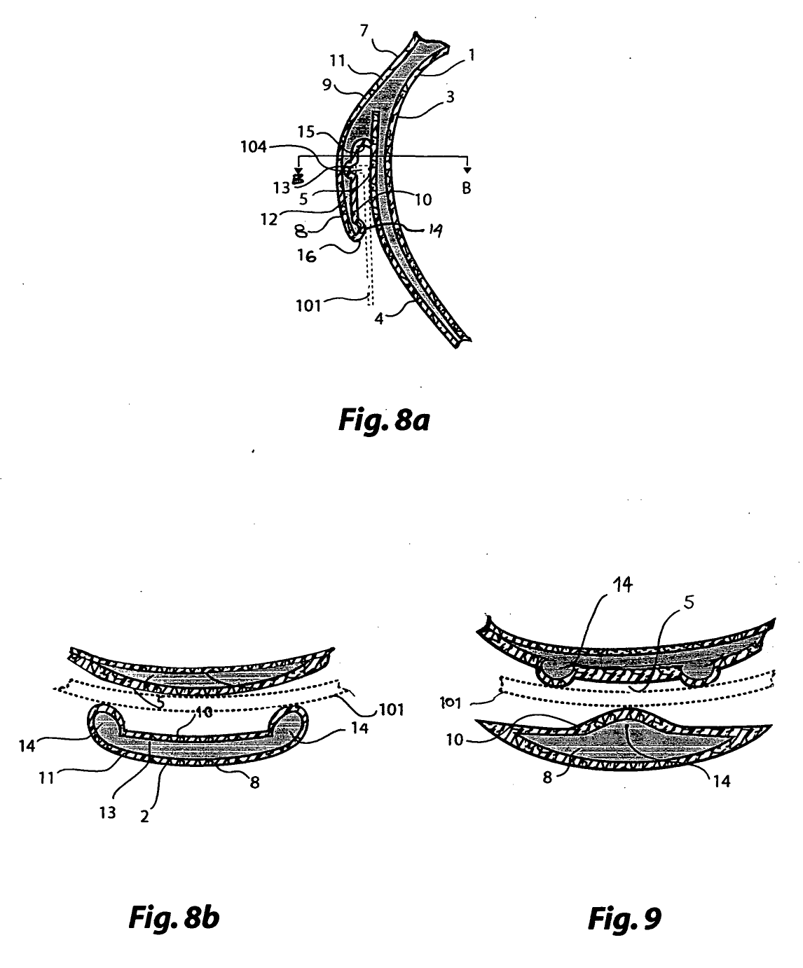

As better represented in FIGS. 3, 5 and 8a, the tab 8 comprises an outer face engaging surface 10 cooperating with inner face engaging surface 5 of the back portion 4 for clipping the utensil on the upper portion (rim) of wall 101 of cookware article 100. In the embodiment of FIG. 3, engaging surfaces are slightly converging and tab 8 is resilient to improve clipping about wall 101 by applying a clamping force at a certain distance below the top of the wall, thus increasing compensation to the moment or rotation applied by the upper (handle) portion 2 of the utensil 1. To ease insertion of the clip over the top edge of wall 101, by simple downward sliding, the free end of tab 8 and engaging surface 5 preferably cooperate to define a tapering inlet 16 (see FIGS. 5 and 8a). The clip device further comprises a stop member 15, integral with root 9, to limit the depth of insertion of the utensil onto the wall 101. Furthermore, surfaces 5 and 10, and possibly the entire efficient portion, can be coated with a resilient material 11, such as a heat resistant silicone, while tab 8 may have a relatively stiffer internal core 12 as illustrated in FIGS. 8a and 8b. Alternatively, a substantial portion of the efficient portion including tab 8 can be molded with a resilient material onto a more rigid central core and handle portion.

In the embodiment illustrated in FIG. 8a and 8b, it is also shown that a transversal groove 13 can be provided near the root 9 of tab 8 to provide a cavity for nesting an outwardly extending lip 104 provided on the rim of certain types of cookware articles. Good contact of wall engaging surfaces 5 and 10 with faces 102 and 103 of wall 101 is thereby preserved. The lower edge of groove 13 is preferably chamfered to prevent lip 104 from locking into groove 13 and enable easy retrieving of the utensil 1 from engagement with the rim of container 100. In this embodiment, the top edge of the groove may provide the function of insertion limitation stop.

The embodiment of FIG. 8a and 8b further shows that protrusions may be provided on surfaces 5 and 10 to better control the locations of contact between the engaging surfaces and wall faces. Since wall 101 is likely to be circular with an unknown diameter, full contact between engaging surfaces 5, 10 and the wall could not be performed. Therefore, in FIG. 8b, it is shown that tab 8 has been shaped to present a pair of lateral protrusions 14, to force contact with the outer face 101 to be performed about two points or two vertical linear continuous or discontinuous ridges. Reciprocally, the same structure can be implemented into engaging surface 5 as illustrated in FIG. 9. When a two-point contact is provided on one of engaging surfaces 5 and 10, the opposing surface (see surface 5 in FIG. 8b) can rely on a single point or single vertical line contact area as for surface 5 in FIG. 8b, which is provided with a curvilinear profile. In the embodiment of FIG. 9, a protrusion has been formed in surface 10 to ensure that contact with the outer face of the wall will occur at the center of the tab, either along a vertical line or at a pin-point location. While three points of contact would provide adequate retention of the utensil 1, a combination providing a pair of laterally spaced-apart contacts on each engaging surface is preferred.

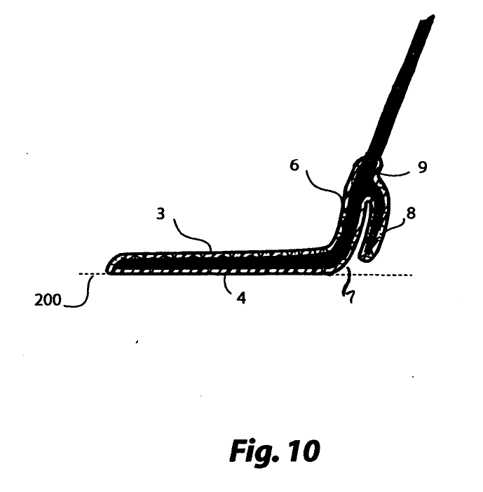

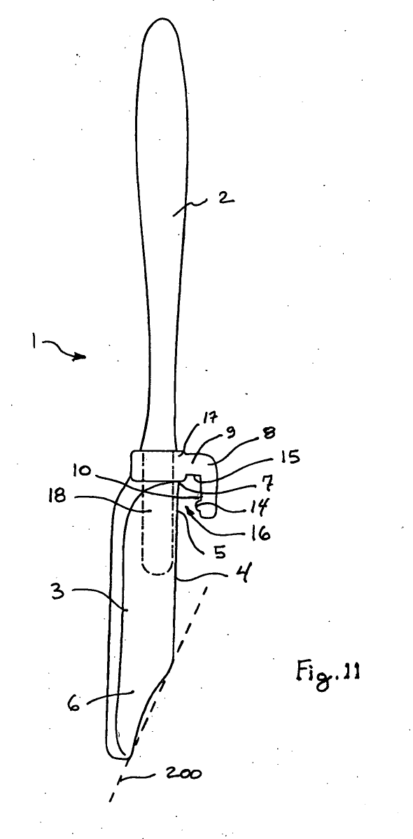

Turning back to FIG. 3, a phantom line 200 has been drawn to represent a virtual plane following the general orientation of the fore portion 6 of the efficient portion 3 of utensil 1. This is to show that positioning the clipping tab 8 properly at the heel portion 7 of the efficient portion 3 does not compromise normal use of the utensil. In FIG. 10, utensil 1 has been represented by a spatula to emphasize that fact. However, for certain types of utensils, the tab 8 may extend from a median portion of the back portion of the efficient portion, without compromising normal use of the utensil, thereby shortening the portion of the efficient portion to be extending within the container. This is possible namely because the structure of the clipping device of the present invention does not require an opening to be provided through the efficient portion of the utensil.

In the embodiment of FIG. 11, a removable clip portion is assembled between the handle portion 2 and the efficient portion 3 of utensil 1 according to an alternate manufacturing technique. The tab 8 projects from a collar 17, actually forming a detachable part of heal portion 7, adapted to be inserted onto a substantially rigid connecting member 18 (acting as stiffer core 12) extending distal from handle 2 for insertion into a bore provided into efficient portion 3 preferably made from a resilient material such as heat resistant silicone. The removable clip portion can be made from the same material as efficient portion 3 or from another stiffer material such as that of handle 2 for instance. Tab 8 is connected to collar 17 through root 9.

For the rest, the detachable clip device is similarly structured and functions as in the above-described embodiments of the invention, with tab 8 cooperating with the back portion 4 of the efficient portion 3 for engaging inner and outer faces of a supporting wall 101 to hold utensil 1.

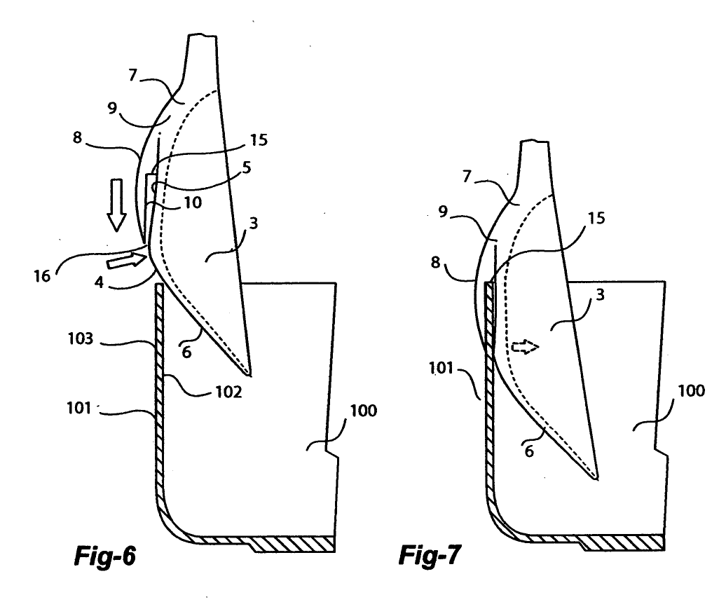

As illustrated in FIGS. 6 and 7, in operation, the back portion 4 of the efficient portion 3 of the integral utensil and clip device 1 has merely to be leaned against the inner face of wall 101, with the free end of tab 8 just the wall, and then pushed downwardly to engage the top of the wall into the inlet 16 of the clip provided by the cooperation of the tab 8 with the engaging surface 5 of the back portion 4 of efficient portion 3. The utensil 1 can thus be properly attached to the rim 101 of cookware article 100, with its handle portion 2 extending generally vertically and with at least the fore portion 6 of its efficient portion 3 extending into container 100 to ensure that any dripping of food residues will return to the food in the container. The proximity of the clipping device from the distal end of the utensil 1 enables the clipping thereof to a variety of containers including low profile pans. Moreover, this is performed without requiring any holding device separate from the integral utensil and clip device 1. It is also worth mentioning that the integral clip provided in the utensil 1 may also be used to store the utensil between uses, by attaching it to any supportive structure comprising a generally vertically extending thin wall, as an alternative to hanging or storage into a drawer.

One can thus easily appreciate that the above described embodiments according to the present invention provide effective solutions for holding a cooking or serving utensil during use with pots, pans or like containers, while maintaining the peripheral area clean. Therefore, it can be seen that the integral utensil and clip device can be advantageously used in miscellaneous applications, by accordingly changing the functionality of the efficient portion thereof.

Although the present invention has been described hereinabove by way of preferred embodiments thereof, it can be modified, without departing from the spirit and nature of the subject invention as defined in the appended claims.

1. A food handling implement, said food handling implement being securable to a wall of a kitchen vessel, said food handling implement comprising:
a food handling section; and
a tongue coupled to said food handling section, at least part of said tongue being in a substantially spaced apart relationship relative to said food handling section for defining an anchoring space therebetween;
whereby said utensil is securable to the wall of the kitchen vessel by at least partially inserting the wall of the kitchen vessel in said anchoring space.

2. A food handling implement as defined in claim 1, further comprising a substantially elongated handle coupled to said food handling section, said handle defining a handle, longitudinal axis, wherein
said food handling section defines substantially opposed food handling section first and second surfaces;
said tongue defines substantially opposed tongue first and second ends and opposed tongues first and second surfaces, said tongue first and second ends defining a tongue longitudinal axis extending therebetween; and
said tongue extends from said food handling section first surface substantially adjacent said tongue first end, said tongue extending from food handling section first surface at a tongue attachment location, said tongue first surface facing at least in part said food handling section first surface.

3. A food handling implement as defined in claim 2, wherein said tongue longitudinal axis is substantially parallel to said handle longitudinal axis.

4. A food handling implement as defined in claim 3, wherein said anchoring space is substantially tapered from said tongue first end towards said tongue second end.

5. A food handling implement as defined in claim 3, wherein said tongue first surface is substantially parallel to said food handling section first surface.

6. A food handling implement as defined in claim 5, wherein said tongue is resiliently mounted to said food handling section first surface for allowing said wall to push at least part of said tongue away from said food handling section first surface upon the at least partial insertion of the wall of the kitchen vessel in said anchoring space.

7. A food handling implement as defined in claim 5, wherein at least one of said tongue and said food implement first surface is covered at least partially by a substantially resilient material.

8. A food handling implement as defined in claim 5 wherein said tongue includes a stop member extending between said tongue attachment location and said tongue first surface, said stop member being substantially perpendicular to said tongue longitudinal axis.

9. A food handling implement as defined in claim 5, wherein the wall of the cooking vessel includes a lip extending therefrom and said tongue includes a tongue recess extending thereinto from said anchoring space, said tongue recess allowing to receive thereinto the lip.

10. A food handling implement as defined in claim 5, wherein said food handling section first surface includes a fore portion and a heel portion, said tore portion being angled relatively to said heel portion, said fore portion defining a fore plane substantially parallel to said fore portion, said tongue extending from said heel portion towards said fore plane over a distance smaller than a distance between said fore plane and said tongue attachment location.

11. A food handling implement as defined in claim 3, wherein a food handling section recess is formed into said food handling section first surface for receiving at least partially thereinto said tongue second end.

12. A food handling implement as defined in claim 3, further comprising a protrusion extending into said anchoring space from at least one of said tongue and said food handling section first surface.

13. A food handling implement as defined in claim 12, comprising at least two protrusions extending into said anchoring space from at least one of said tongue and said food handling section first surface, said at least two protrusions being substantially equidistant from said tongue attachment location.

14. A food handling implement as defined in claim 1, further comprising
a substantially elongated handle coupled to said food handling section, said handle defining a handle longitudinal axis; and
a collar coupled to said tongue, said collar being removably attachable to said handle, thereby allowing the attachment and removal of said tongue to and from said handle.

15-20. (canceled)
